(19) United States
(12) Patent Application Publication
(10) Pub. No.: US 2024/0070597 A1
(43) Pub. Date: Feb. 29, 2024

(54) SYSTEM AND METHOD FOR GENERATING AND USING AN ORGANIZATIONAL CULTURE GRAPH FOR GAUGING THE CULTURAL HEALTH OF AN ORGANIZATION

(71) Applicant: Airspeed, Inc., Vancouver, WA (US)

(72) Inventors: Doug Camplejohn, Sausalito, CA (US); Dan Chiao, Beaverton, OR (US); Hiroaki Oyaizu, Hoboken, NJ (US)

(21) Appl. No.: 18/237,789

(22) Filed: Aug. 24, 2023

Related U.S. Application Data
(60) Provisional application No. 63/400,546, filed on Aug. 24, 2022.

(51) Int. Cl. G06Q 10/067; G06Q 10/0637

(52) U.S. Cl. CPC G06Q 10/067; G06Q 10/06375

(57) ABSTRACT

A system and method for generating and using an organizational culture graph for gauging the cultural health of an organization are disclosed herein. An example embodiment includes: ingesting input data from a culture graph generation platform operating within an organization; parsing the input data to generate corresponding nodes of an organizational culture graph; generating edges of the organizational culture graph, the edges including ownership, reaction, and comment edges; generating connection edges of the organizational culture graph by following each reaction and comment edge to a post, then following the ownership edge to a creator of the post; and generating engagement metrics, connectedness metrics, and qualitative assessments from the organizational culture graph and the corresponding communication flows within the organization.

### PRIORITY PATENT APPLICATION

This non-provisional patent application draws priority from U.S. provisional patent application Ser. No. 63/400,546; filed Aug. 24, 2022. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2021-2023, Airspeed, Inc., All Rights Reserved.

### TECHNICAL FIELD

This patent document pertains generally to data processing, data communication networks, content analysis, and more particularly, but not by way of limitation, to a system and method for generating and using an organizational culture graph for gauging the cultural health of an organization.

### BACKGROUND

Traditionally, organizational cultural health and chemistry have been monitored through means such as surveys (e.g., team surveys and individual interviews), Human Resources (HR) statistics (e.g., employee retention rates), and monitoring of communications outside of the organization (e.g., Glassdoor.com). Most of these means are prone to misuse due to their incompleteness and susceptibility to biases and intimidation. For example, surveys have sample biases due to the lack of responses and subtle intimidation from the surveyor. Additionally, retention rates can be highly influenced by the overall economy, which is unrelated to the organizational cultural health and chemistry. In some cases, indicators of organizational problems may be backward-looking or become apparent only when the problems have become acute (e.g., retention rate dropping significantly). In other cases, the input data to these means may be highly susceptible to external factors, like the overall health of the economy, and thus may prove unreliable.

### SUMMARY

A system and method for generating and using an organizational culture graph for gauging the cultural health of an organization are disclosed herein. In the various example embodiments disclosed herein, a Culture Graph Generation system is configured to gauge the cultural health of the organization by modelling the connections of the users within an organization and creating unique and relevant analytics and metrics. The model and the analytics are computed from user interactions within a Culture Graph Generation platform, which can be implemented as a social media platform primarily for intra-organizational use. The Culture Graph Generation system is innovative and different from prior measures of cultural health; because, the system does not rely on surveys (e.g., surveys have sample biases due to the lack of responses and subtle intimidation from the surveyor) nor indirect metrics such as retention rate (e.g., retention rates can be highly influenced by the overall economy). In addition, the Culture Graph Generation system produces reports of the cultural health of an organization and generates recommendations on how to improve the cultural health of the organization.

In the various example embodiments disclosed herein, a “User” can be defined as an individual within or a member of an organization. A “Connection” can be defined as a shared characteristic between a plurality of users. In one example, a shared characteristic can be a shared topic in one or more posts made by users in the Culture Graph Generation platform. An “Interaction” can be defined as any form of communication within a group of people, e.g., a post made by a user, a reaction to a post, or a comment on a post. A “Resonance” can be defined as the degree to which a given Interaction results in further Interactions. A “Topic” can be defined as the subject matter of an interaction. Each interaction can have multiple Topics associated with the interaction.

In an example embodiment, the Culture Graph Generation system uses the user activities (usage) data of the Culture Graph Generation platform and other similar social networks, and outputs among the following types of information and/or data:
A set of metrics and analytics, shown in a dashboard as part of a user interface; and
A report of the cultural health for each organization within the Culture Graph Generation platform identifying cultural strengths and weaknesses, and providing recommendations on how to improve the organization's cultural health.

The disclosed example embodiments provide a system for quantifying and qualifying the cultural health and chemistry of an organization based on the organization participants' interactions on a social network platform (e.g., the Culture Graph Generation platform). As a particular example, many companies actively try to foster a good work environment; but, most of them struggle to understand what their existing culture is and how to improve it. The Culture Graph Generation system is designed to give the members of an organization a concrete set of measures to describe the organizational culture and health, and identify possible improvements.

The disclosed example embodiments of the Culture Graph Generation system enable several use cases. For example, the Culture Graph Generation system is an effective tool to gain insight on which topics are highly engaging and connecting for an organization. The Culture Graph Generation system can leverage this insight to surface and highlight content that might increase the organization's connectedness, thereby leading to a more cohesive group of users that collaborate more effectively. The Culture Graph Generation system can also leverage this insight to recommend topics to user subgroups within an organization, again with the goal of creating a more connected organization. In another use case, the Culture Graph Generation system can provide organization manager or management coaching. The Culture Graph Generation system and its reports and metrics can be used to coach the management of an organization to allow the manager to foster a healthier workplace. Additionally, the Culture Graph Generation system can provide feature development. For example, by analyzing the culture graphs of many organizations, the Culture Graph Generation system can gain insight into the best practices for fostering good cultural health in a particular client organization. The Culture Graph Generation system can use this insight to develop features, programs, or strategies that facilitate and enforce the best practices for the client organizations. In a particular embodiment, artificial intelligence (AI) systems and trained models can be used to analyze the culture graphs of many organizations to detect patterns of both beneficial and detrimental organizational behaviors and practices. Details of various example embodiments are disclosed below.

### BRIEF DESCRIPTION OF THE DRAWINGS

The various embodiments are illustrated by way of example, and not by way of limitation, in the figures of the accompanying drawings in which:

FIGS. 1 and 2 illustrate example embodiments of the system and method for generating and using an organizational culture graph for gauging the cultural health of an organization as disclosed herein; and

FIG. 3 illustrates a processing flow diagram that illustrates an example embodiment of a method as described herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

A system and method for generating and using an organizational culture graph for gauging the cultural health of an organization are disclosed herein. In the various example embodiments disclosed herein, the Culture Graph Generation system can obtain or ingest input data from a variety of sources, but mainly from the Culture Graph Generation platform. The data sourcing and data ingestion into the Culture Graph Generation system are described in more detail below. Once the data is received, the Culture Graph Generation system can use a model to generate an organizational culture graph. A variety of metrics, analytics, and assessments can be generated from or with the organizational culture graph to gauge the cultural health of an organization. Further details of example embodiments are disclosed below.

### Data Sourcing and Ingestion

The primary data source for the Culture Graph Generation system is the Culture Graph Generation platform software application (app). The Culture Graph Generation platform is a social network platform primarily consisting of users, posts, and user interactions with posts, specifically created to foster social (non-work-related) and cultural interactions between users within an organization. Users from outside a given organization typically cannot access the content and interactions created within the organization; and thus, the Culture Graph Generation platform creates a well-controlled environment for data analytics particular to that organization.

The users of the Culture Graph Generation platform can optionally connect their accounts to other external services, such as Slack™, LinkedIn™, etc. (via external integrations). In such cases, the actors and interactions within external services may be available as inputs to the Culture Graph Generation system; however, the use of the external services or inputs from external services is optional and not required for the operation of the Culture Graph Generation system. It will be apparent to one of ordinary skill in the art in view of the disclosure herein that a variety of external services can be (but do not need to be) used with the Culture Graph Generation system disclosed herein.

### Input Data

In an example embodiment, the input data comprises data from actors or users and their interactions within the Culture Graph Generation platform. The details of the actors and interactions used in the models and analytics of the Culture Graph Generation system are described below.

In the various example embodiments disclosed herein, an “Actor” or “User” can be defined as an individual within or a member of an organization. Each Actor or User can have several associated characteristics, including:
Interests—a list of text strings that categorizes the user's interests. For example, “outdoors” or “music.”
Location—Geographical location, Longitude and Latitude, or the like, and a common name associated with the geographical location formatted as “City/Town, Country.”
Role within the organization—A role can be a job title or functional responsibility within the organization.

In the various example embodiments disclosed herein, an “Interaction” can be defined as any form of communication within a group of people, e.g., a post made by a user, a reaction to a post, or a comment on a post. In particular, each Interaction can be one of several types with several associated characteristics, as detailed below.
Post
   Creator—The user identifier (ID) of the user who created the post.
   Content—The content of the post, including:
      Hashtags—a list of text strings in the content text that start with a hashtag symbol.
      Text—a text string of the content of the post, with all formatting removed.
      Media—a list of media IDs pointing to both images and videos uploaded by the user who created the post. The IDs may be cross-referenced against the database containing the actual content of the media during the analysis phase.
   Post creation date/time.
   Post type—Within the Culture Graph Generation platform, a user can create several different types of posts depending on the situation. For example, a post can be a birthday card, a new hire welcome card, a work anniversary card, etc.
Reaction (interaction)
   Target post ID—This is the identifier (ID) of the post for which the reaction is created.
   Reacting User—This is the ID of the user who is reacting to the post.
   Reaction type—In the Culture Graph Generation platform, a user can react using several different reaction types, such as “laugh”, “sad”, etc.
Comments (interaction)
   Target post ID—This is the ID of the post for which the reaction is created.
   Commenting User—This is the ID of the user who is commenting on the post.
   Content—The content of the comment, including:
      Text—this is the actual content of the comment as a text string.
      Hashtags—a list of text strings in the comment text that start with a hashtag symbol.
   Comment creation date/time.

For optional data from external integrations, the Culture Graph Generation system can parse their data formats and extract the analogous information from them.

### The Model

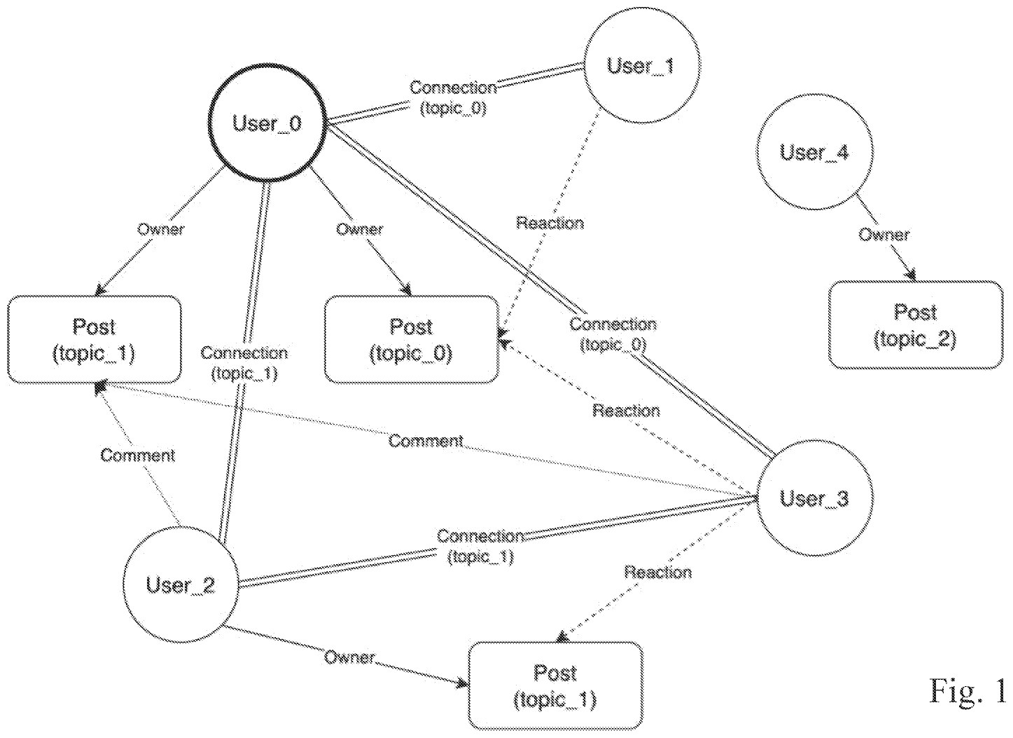

In the various example embodiments disclosed herein, the organizational culture graph is a network graph of users and interactions constructed from the ingested data by the Culture Graph Generation system. The organizational culture graph is comprised of two types of nodes and four types of edges. These node and edge types are described below. FIG. 1 is an example of a culture graph of a fictitious organization with five members or users. As shown in the example of FIG. 1, each user may (or may not) be connected to one or more other users based on shared topics in postings. Note that in the example shown in FIG. 1, User_4 is in isolation; because, the user has not made any connections to other users within the organization.

The Culture Graph Generation system can analyse the content of posts, reactions, or comments communicated within the Culture Graph Generation platform to populate the culture graph of the organization. The organizational culture graph can provide valuable insight into the flow of communication between users in the organization, from which the cultural health of the organization can be determined.

### Nodes

In an example embodiment, there are two node types: User and Post. Each post node has topic and sentiment labels determined based on the content of the post. As shown in the example of FIG. 1, a cultural champion user (e.g., User_0, a hub of many user connections) has been identified with a bold border.

### Edges

In the example embodiment, there are four types of edges in the organizational culture graph. These edge types are described in the table below. These edge types are also shown in the example of FIG. 1.

| | Source | Target | | |
|---|---|---|---|---|
| Edge Type | Node | Node | Labels | Description |
| Ownership | User | Post | | Denotes the User to whom a given post |
| | | | | belongs (or was created by) |
| Reaction | User | Post | Sentiment | Denotes the User who has reacted to a post |
| Comment | User | Post | Set<(topic, | Denotes the User who has commented on a |
| | | | sentiment)> | post. If a comment contained additional topics |
| | | | | not present in the target post, the topic is added |
| | | | | to the edge's labels. |
| Connection | User | User | List<topic> | Denotes a connection between two Users |
| | | | | through a shared topic. A connection is made |
| | | | | when one User interacts with another User |
| | | | | through a post. The connection is an indication |
| | | | | that two Users have directly interacted with |
| | | | | each other. |

### Analytics/Metrics

In the various example embodiments disclosed herein, the Culture Graph Generation system can quantify the organizational culture graph by determining or computing metrics related to the organizational culture graph and the corresponding communication flows within the organization. These metrics can include measures of engagement and connectedness and other qualitative assessments as described in more detail below.

### Engagement

Engagement is a measure of how many follow-up interactions a single originating interaction generates. The engagement measure depends on the topic and is computed by the Culture Graph Generation system as the expectation value of the number of reaction and comment edges given a post with specified topics. The overall engagement is computed as the expectation value after marginalizing the reaction and comment distribution over all topics.

### Connectedness

Connectedness is a measure of how broadly the users interact with each other. The connectedness measure is computed as the number of connection edges divided by the total number of possible connection edges, which is N*(N−1)/2. The resulting connectedness measure ranges from 0.0 to 1.0.

Connectedness is calculated overall by marginalizing over topics associated to connection edges. For select significant topics, the Culture Graph Generation system can also be configured to calculate topic-connectedness, where, given a topic, a connection edge is not considered if the topic is not in its labels list.

### Qualitative Assessments

In addition to the engagement and connectedness metrics as described above, the Culture Graph Generation system of an example embodiment can also be configured to determine or calculate a variety of additional qualitative assessments from the organizational culture graph and the corresponding communication flows within the organization. A few of these qualitative assessments are described below.
Identification of significant topics
   Popular or unpopular topics—This analysis is based on the frequency of occurrence of each topic.
   Topics that generate the most or least interactions—This analysis is based on computing the per-topic engagement scores.
Identification of culture champions—Culture champions are the hubs of the culture graph and are identified by finding users who have significantly more edges than the average user in the organization.
Identification of disconnected users or clusters of disconnected users—These disconnected clusters are found by performing a reachability test. In the example embodiment, the reachability test is configured to place two users in the same cluster if one user can be reached from another user by following the connection edges.

### Culture Graph Construction

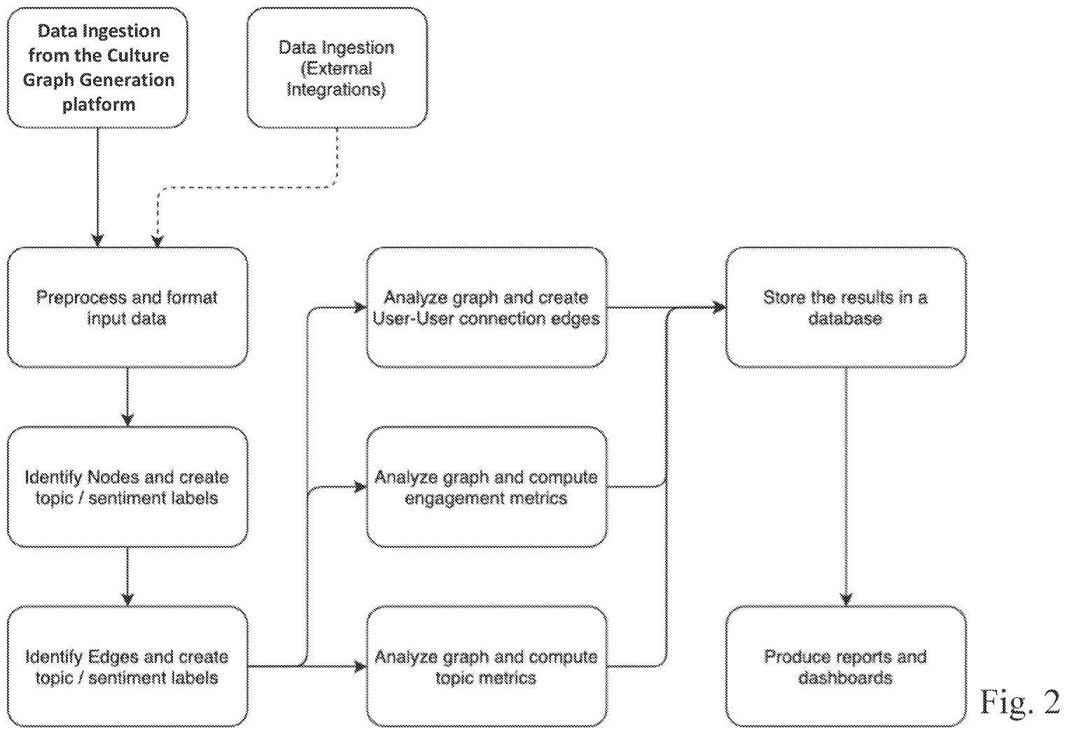

Referring now to FIG. 2, a methodology used by the Culture Graph Generation system of an example embodiment to generate the organizational culture graph is illustrated. Note that the dotted lines shown in FIG. 2 denote optional inputs. The primary input data received by the Culture Graph Generation system of the example embodiment is ingested from the culture graph generation platform as described above. Optionally, the Culture Graph Generation system can also receive data from external integrations.

From the ingested input data, the Culture Graph Generation system can parse out all users and posts and form corresponding nodes of the organizational culture graph. Each user's list of interests is converted into a list of topics and added to the user's labels. Each post's content is also analyzed and mapped to a set of topic-sentiment pairs, which are then added to the post's labels.

Once the nodes of the organizational culture graph are created, the Culture Graph Generation system can create the edges of the organizational culture graph in a series of steps as described in more detail below.
Ownership edges—Ownership edges denote users to whom a given post belongs (or was created by). The post ownership can be created directly from the creator field of the post input data.
Reaction and Comment edges—These edges map one-to-one with all comments and reactions from the input data. For each reaction and comment from the input data, the Culture Graph Generation system can analyze the sentiment expressed in each reaction and comment and label the edges accordingly.
Connection edges—These edges can be generated by the Culture Graph Generation system by following each reaction and comment edge to a post, then following the ownership edge to the creator of the post. These edges essentially connect two users through a set of direct interactions.

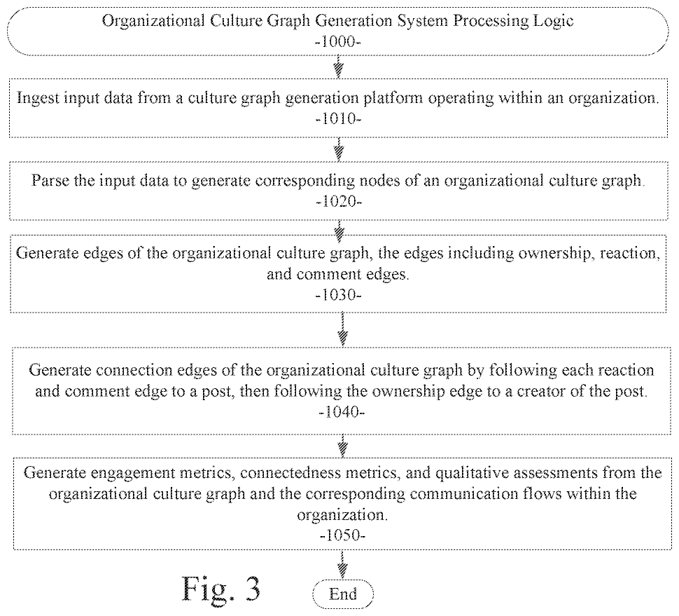

Referring now to FIG. 3, a processing flow diagram illustrates an example embodiment of a method implemented by the system as described herein. The method 1000 of an example embodiment includes: ingesting, by use of a data processor, input data from a culture graph generation platform operating within an organization (processing block 1010); parsing, by use of the data processor, the input data to generate corresponding nodes of an organizational culture graph (processing block 1020); generating, by use of the data processor, edges of the organizational culture graph, the edges including ownership, reaction, and comment edges (processing block 1030); generating, by use of the data processor, connection edges of the organizational culture graph by following each reaction and comment edge to a post, then following the ownership edge to a creator of the post (processing block 1040); and generating, by use of the data processor, engagement metrics, connectedness metrics, and qualitative assessments from the organizational culture graph and the corresponding communication flows within the organization (processing block 1050).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An organizational culture graph generation system comprising:
a data processor; and
an organizational culture graph generation module, executable by the data processor, the organizational culture graph generation module being configured to:
ingest input data from a culture graph generation platform operating within an organization;
parse the input data to generate corresponding nodes of an organizational culture graph;
generate edges of the organizational culture graph, the edges including ownership, reaction, and comment edges;
generate connection edges of the organizational culture graph by following each reaction and comment edge to a post, then following the ownership edge to a creator of the post; and
generate engagement metrics, connectedness metrics, and qualitative assessments from the organizational culture graph and the corresponding communication flows within the organization.

2. The system of claim 1 being further configured to ingest data from external integrations.

3. The system of claim 1 wherein the nodes are of a type selected from a group consisting of: user and post.

4. The system of claim 1 wherein the edges are of a type selected from a group consisting of: ownership, reaction, comment, and connection.

5. The system of claim 1 wherein the engagement metrics include an expectation value corresponding to a quantity of reaction and comment edges given a post with specified topics.

6. The system of claim 1 wherein the connectedness metrics include a connectedness value corresponding to a quantity of connection edges divided by a total quantity of possible connection edges.

7. The system of claim 1 wherein the connectedness metrics include a topic-specific connectedness value.

8. The system of claim 1 wherein the qualitative assessments include an indication of significant topics.

9. The system of claim 1 wherein the qualitative assessments include an identification of culture champions corresponding to users who have significantly more edges than an average user in the organization.

10. The system of claim 1 wherein the qualitative assessments include an identification of disconnected users or clusters of disconnected users.

11. A method comprising:
ingesting, by use of a data processor, input data from a culture graph generation platform operating within an organization;
parsing, by use of the data processor, the input data to generate corresponding nodes of an organizational culture graph;
generating, by use of the data processor, edges of the organizational culture graph, the edges including ownership, reaction, and comment edges;
generating, by use of the data processor, connection edges of the organizational culture graph by following each reaction and comment edge to a post, then following the ownership edge to a creator of the post; and
generating, by use of the data processor, engagement metrics, connectedness metrics, and qualitative assessments from the organizational culture graph and the corresponding communication flows within the organization.

12. The method of claim 11 including ingesting data from external integrations.

13. The method of claim 11 wherein the nodes are of a type selected from a group consisting of: user and post.

14. The method of claim 11 wherein the edges are of a type selected from a group consisting of: ownership, reaction, comment, and connection.

15. The method of claim 11 wherein the engagement metrics include an expectation value corresponding to a quantity of reaction and comment edges given a post with specified topics.

16. The method of claim 11 wherein the connectedness metrics include a connectedness value corresponding to a quantity of connection edges divided by a total quantity of possible connection edges.

17. The method of claim 11 wherein the connectedness metrics include a topic-specific connectedness value.

18. The method of claim 11 wherein the qualitative assessments include an indication of significant topics.

19. The method of claim 11 wherein the qualitative assessments include an identification of culture champions corresponding to users who have significantly more edges than an average user in the organization.

20. The method of claim 11 wherein the qualitative assessments include an identification of disconnected users or clusters of disconnected users.
